(19) United States
(12) Patent Application Publication
(10) Pub. No.: US 2008/0272277 A1
(43) Pub. Date: Nov. 6, 2008

(54) APPARATUS AND METHOD FOR CONTROLLING BRIGHTNESS OF LIGHT SOURCE AND DISPLAYING APPARATUS

(75) Inventor: Hsien-Wang Wei, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 11/769,723

(22) Filed: Jun. 28, 2007

(30) Foreign Application Priority Data
May 2, 2007 (TW) 96115635

(51) Int. Cl. G01J 1/32

(52) U.S. Cl. 250/205

(57) ABSTRACT

The invention provides a method and apparatus for controlling brightness of illumination systems, illumination systems and display using the same. The apparatus includes a photo-sensor and a control circuit. The photo-sensor detects a luminous output of the illumination systems and correspondingly outputs a detection signal. The control circuit gets the detection signal during the light source being turned off, and adjusts and controls the brightness according this feedback signal. The method and apparatus of the invention can offer a stable output to illumination systems and displays using the same.

### CROSS-REFERENCE TO RELATED APPLICATION

This application claims the priority benefit of Taiwan application serial no. 96115635, filed May 2, 2007. All disclosure of the Taiwan application is incorporated herein by reference.

### BACKGROUND OF THE INVENTION

1. Field of the Invention

The present invention relates to an apparatus and a method for controlling a light source, and more particularly to an apparatus for controlling the brightness of a light emitting diode (LED) light source, a light source system and a display apparatus using the same, and a controlling method thereof.

2. Description of Related Art

An LED with a low working voltage (only 1.5-3V) is capable of actively emitting lights, and has a specific brightness, which may be adjusted through adjusting a voltage or a current, and meanwhile, the LED has advantages of impact resistance, anti-vibration, and a long service life (100,000 hours). Therefore, the LED has been widely used in various terminal devices, including automobile headlights, traffic lights, text displays, post boards, and large-screen video display devices, as well as commonly-used in building illuminations and LCD backlights.

With the increasing of LED efficiency and brightness and the reducing of the cost, the LED market has been well developed and gradually become matured. Especially in the field of high-end display, a display platform has a high requirement on the matching of the brightness for a light source, and requires uniform and consistent display colors and brightness, so as to ensure the display effect always looks like new.

However, since the light intensity of the light source will be changed due to the aging of the light source itself or a temperature factor (the luminous intensity is increased or decreased), in order to maintain the light source in a stable state, the changing of the light source must be known, so as to compensate and control the light source according to the feedback, thereby achieving the purpose of maintaining the stable light source.

There are two conventional light modulation methods, namely, an analog modulation method and a pulse width modulation (PWM) method. The analog modulation method is to adjust the brightness through changing a current flowing through the LED. The disadvantage of the analog modulation method lies in that, the LED color offset occurs and an analog control signal is required. The other light modulation method is the PWM light modulation method, which utilizes a constant current to drive the LED, and achieves the purpose of adjusting the brightness by using the duty ratio for turning on and turning off the LED. For example, the constant current of 20 mA is used to drive the LED, and when the duty ratio is 50%, the generated brightness is one half of the brightness generated when the duty ratio is 100%. Since a constant current is employed to drive the LED, the PWM light modulation will not cause the problem of color offset. Meanwhile, in order to ensure that the flickering phenomenon due to turning on and off the LED is invisible to the viewer, the switching frequency for turning on and off the light source should be sufficiently high. The maximum PWM frequency depends on the time that the power is turned on and makes responses, and theoretically, it cannot be sensed by the viewer, so long as the switching frequency is higher than 200 Hz.

The relevant conventional arts may be obtained with reference to U.S. Pat. No. 6,127,783, 6,894,442, and 6,495,964.

The common feature of the above conventional controlling methods is to use a photo-sensor to detect a light source, and to get the output information of the photo-sensor when the light source is lightened (in a high level period), and then, the light source is adjusted according to the feedback, thereby achieving the function of compensating the brightness. The control timing chart is as shown in FIG. 1.

However, the conventional controlling method is affected by system noises caused by a driver when the light source is lightened. Referring to FIG. 2, the problem discussed in the present invention is shown, as for an LED drive circuit, when a drive current is outputted, i.e., in the time region 24 where the LED light source is lightened (in a high level period), large noises are generated in the circuit system, simultaneously. However, the output signal itself detected by the photo-sensor is a weak electric signal, and the conventional controlling method is to sample the data when the LED light source is lightened with large noise. This reduces the signal-to-noise ratio of the detection signal and affects the accuracy of an actual detected result. Especially, a large-scale LED matrix light source requires a large drive current, and accordingly, the noises generated in the circuit system are even larger, which possibly overwhelms the detected output signal, and even causes that the required feedback signal cannot be detected.

In view of the above, it has become an urgent development and research issue for persons in the art to provide a technology of controlling the brightness of a light source, which may effectively reduce noise interference and enhance detection accuracy.

### SUMMARY OF THE INVENTION

The present invention is directed to an apparatus for controlling brightness of a light source, which may effectively reduce noise interference and enhance detection accuracy.

The present invention is directed to a method for controlling brightness of a light source, which may effectively reduce noise interference and enhance detection accuracy.

The present invention is directed to a light source system having a stable display effect.

The present invention is directed to a display apparatus having a stable display effect.

The present invention provides an apparatus for controlling brightness of a light source, so as to achieve a stable light source. The apparatus includes: a photo-sensor, for detecting a change of the light source; and a lighting management and control circuit, for providing a control and adjustment signal for the light source according to a feedback signal of the photo-sensor. The lighting management and control circuit gets an output signal of the photo-sensor when the light source is turned off, and calculates and adjusts the light source according to the detection signal, thereby compensating the change of the brightness of the light source.

The present invention provides a method for controlling brightness of a light source, which includes: detecting a change of the light source by using the photo-sensor; and getting an output signal of the photo-sensor when the light source is turned off, so as to compensate the change of the brightness of a light source according to the feedback of the photo-sensor, thereby achieving a stable light source.

The light source system of the present invention includes: a light source; a photo-sensor, for detecting a change of the light source; and a lighting management and control circuit, for providing a control and adjustment signal for the light source according to a feedback signal of the photo-sensor. The lighting management and control circuit gets the output signal of the photo-sensor when the light source is turned off, and calculates and adjusts the light source according to the detection signal, thereby compensating the change of the brightness of the light source and achieving a stable display effect.

The display apparatus of the present invention includes a light source system, in which the light source system includes a light source; a photo-sensor, for detecting a change of the light source; and a lighting management and control circuit, for providing a control and adjustment signal for the light source according to a feedback signal of the photo-sensor. The lighting management and control circuit gets the output signal of the photo-sensor when the light source is turned off, and calculates and adjusts the light source according to the detection signal, thereby compensating the change of the brightness of the light source and achieving a stable display effect.

Compared with the prior art, the advantages of the present invention lie in that, the method for controlling the brightness of the light source provided by the present invention is to sample the data when the light source is turned off, and since a light source driver is also turned off while the light source is turned off, the influence of system noises caused by the driver when the light source is lightened is avoided, the signal-to-noise ratio of a signal is increased, and the detection accuracy of the change of the light source is improved, and thereby more effectively controlling the brightness of the light source, and offering a light source for the light source system and the display apparatus.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a control timing chart of brightness and color balance of a conventional light source.

FIG. 2 is a schematic view of the relationship between the state of a light source and noises of a measurement signal for the light source.

FIG. 3 is a schematic view of a brightness-control mechanism according to an embodiment of the present invention.

FIG. 4 is a schematic control timing chart according to an embodiment of the present invention.

FIGS. 5 and 6 are schematic views of a brightness-control mechanism according to another embodiment of the present invention.

FIG. 7 is a schematic control timing chart according to another embodiment of the present invention.

FIG. 8 is a schematic view of a mechanism of a potential diagram showing rising (due to being changed), maintaining, and attenuating of the voltage at a sampling point.

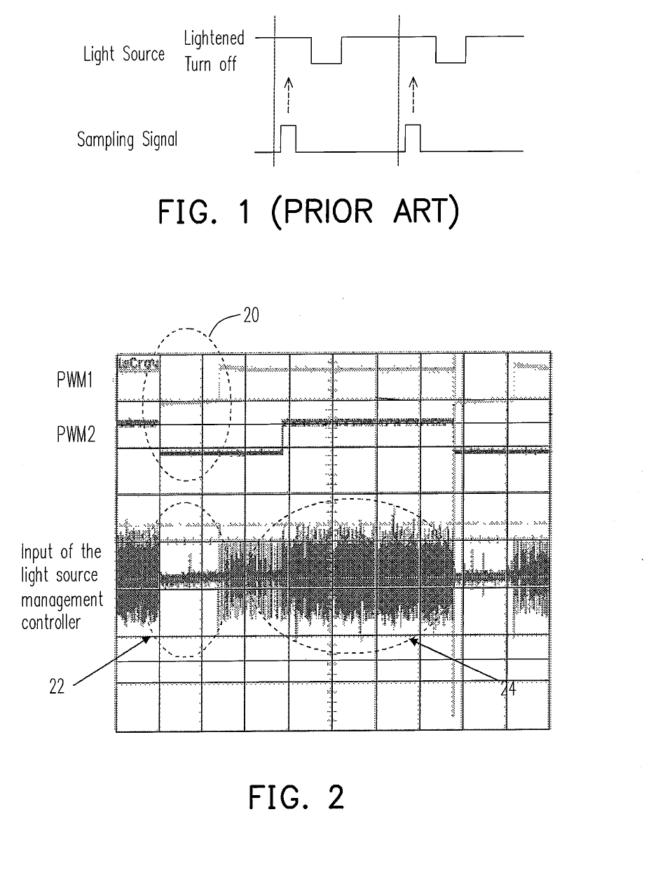

### DESCRIPTION OF EMBODIMENTS

In order to solve the problem of a change of a light source, it is further researched deeply in the present invention. FIG. 2 is a schematic view of the relationship between the state of a light source and noises of a measurement signal for the light source. Referring to FIG. 2, for example, two LEDs having different colors are controlled by voltage modulation signals PWM1 and PWM2, respectively. In a time region 20, both the LEDs are in an OFF state, i.e., the light source is fully turned off. In addition, both the LEDs are in an ON state in the time region where the PWM1 and PWM2 are in a high level. After a change of the light source is converted into an electrical signal through the photo-sensor, the electrical signal passes through a filter to obtain a light intensity signal, which is commonly used as an input signal for a light source management controller. A signal in the region 22 is corresponding to a state 20 that light emitting elements are all turned off, and a signal in the region 24 is corresponding to a state that the light emitting elements are all turned on. In terms of a noise level of the signal, the signal in the region 22 has a more stable value in comparing with the signal in the region 24.

It should be noted herein that, even under the state 20 that the light emitting elements are turned off, since an RC circuit of the filter still kept a potential, the attenuation of the potential has a corresponding relationship with the performance of the light emitting elements. Hence, even though a signal is measured in the state 20 that the light emitting elements are turned off, if the time point for sampling is fixed, it still can be determined whether the light emitting efficiency of the light emitting elements is changed or not. Therefore, after the behavior analysis in FIG. 2, the present invention provides a brightness-control mechanism of a light source, so as to achieve a more accurate compensation control on the light source and achieve a stable light source. Some embodiments are described below to demonstrate the features of the present invention, but the present invention is not limited thereby.

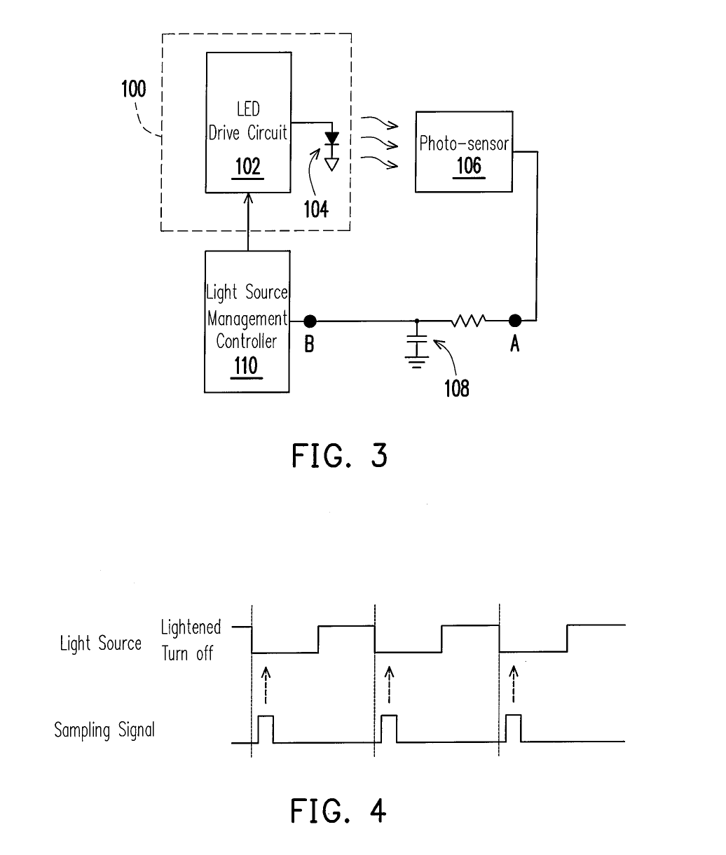

FIG. 3 is a schematic view of a brightness-control mechanism of a light source according to an embodiment of the present invention. FIG. 4 is a control timing chart according to an embodiment of the present invention. Referring to FIGS. 3 and 4, a specific embodiment is given to demonstrate the control and compensation of the light source system 100 of the present invention. The light source system 100 is, for example, a light source module of the LED, which includes, for example, a light source 104 and an LED drive circuit 102. The light source 104 is, for example, a light emitted from an LED, which is not limited to emitting white light, and may be a white light source composed of red, green, and blue lights emitted from red, green, and blue emitting elements. The light emitting element is not restricted to an LED, but the LED is taken as an example for demonstration in the present invention.

A light source control system provided by the present invention includes a photo-sensor 106 and a light source management controller 110. An output of the photo-sensor 106 is connected to the light source management controller 110 through an appropriate filter circuit 108. In the control method of the present invention, a change of the brightness of the LED light source 104 is detected through the photo-sensor 106. The light source management controller 110 receives a detection signal from the photo-sensor 106 and outputs a control and adjustment signal to the LED drive circuit 102, thereby controlling and adjusting the brightness or color of the LED light source 104.

FIG. 4 shows the control timing diagram of the control method according to the present invention, and the control method of the present invention is to measure the LED light source 104 or perform the data sampling when the LED light source 104 is turned off (in a low level period as shown in FIG. 4). An output voltage of the photo-sensor 106 (i.e., the voltage at Point “A”) is changed with the changing of the light intensity of the LED light source 104; and through the appropriate filter circuit 108, the voltage at Point “B” (the input voltage of the light source management controller 110) is greatly reduced as the response speed of the intensity change for the LED light source 104. If the switching speed for turning on and off the LED light source 104 is sufficiently high, when the light source is turned off, the voltage at Point “B” is maintained to be stable. According to the phenomenon in FIG. 2, the control method of the present invention is to perform the data sampling when the LED light source 104 is turned off, i.e., in the low level period shown in FIG. 4, so as to obtain the voltage at Point “B” to serve as a reference for modifying the LED light source 104.

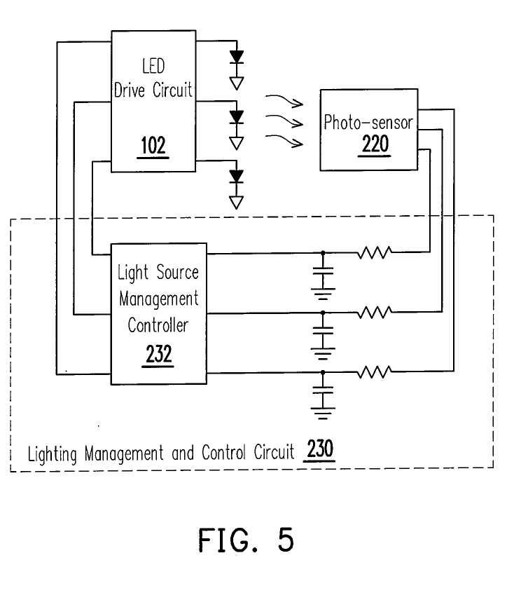

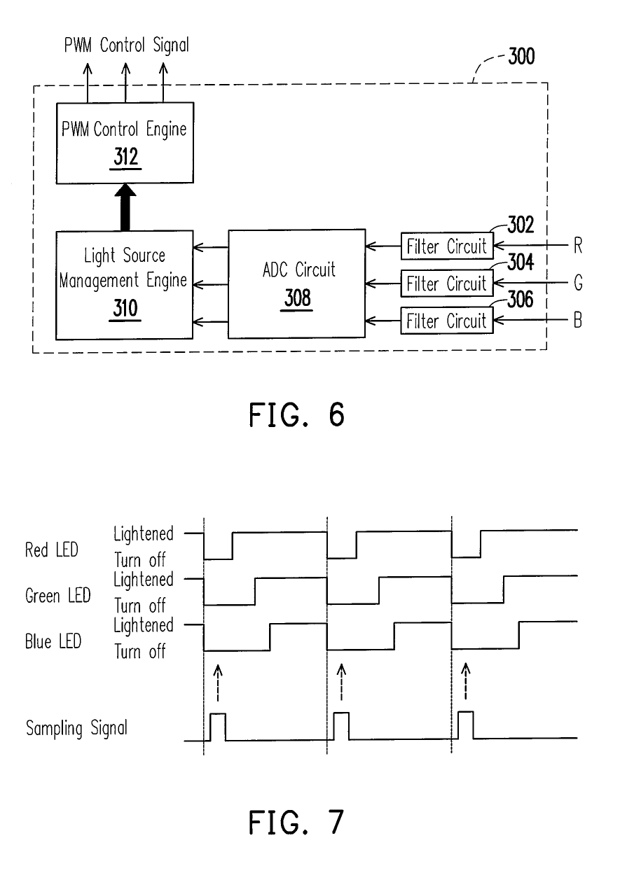

FIG. 5 is a schematic view of a complete architecture of a light source management system according to an embodiment of the present invention. FIG. 6 is a schematic view of the lighting management and control circuit in the light source management system (shown in FIG. 5) according to an embodiment of the present invention. Referring to FIG. 5, an embodiment of the controlling method and apparatus of the present invention is shown, for example, the application of an RGB LED matrix light source, which is different from the first embodiment in that, the light source is the RGB LED matrix light source, and the photo-sensor 220 is used to detect the changes of the brightness for red, green, and blue LED light sources respectively, so as to provide an optical feedback signal for the lighting management and control circuit 230. The lighting management and control circuit 230 includes a light source management controller 232 for controlling the change of the brightness for the light source through using the detection signals of red, green, and blue LEDs outputted by the photo-sensor 220.

FIG. 6 shows an embodiment of the lighting management and control circuit 300. Referring to FIG. 6, the lighting management and control circuit 300 includes filter circuits 302, 304, and 306 respectively connected to the red, green, and blue LEDs, an analog to digital converter circuit (an ADC circuit) 308, a light source management engine 310, and a PWM modulation control engine 312. The lighting management and control circuit 300 aims at converting an analog voltage outputted by the photo-sensor 220 into a digital value, so as to obtain the individual brightness information from these digital values by digital processing, and the specific operating principle is described as follows:

(1) The change of the brightness of the LED is detected through the photo-sensor, and the intensities of the red, green, and blue LEDs are converted into voltage changes.

(2) After passing through the appropriate filter circuits 302, 304, and 306, the output voltage of the photo-sensor is analog-digital converted by the ADC circuit 308, and the analog voltage signal is converted into a digital value for being provided to the light source management engine 310.

(3) The light source management engine 310 compares and calculates the digital value obtained in Step (2) with a target value, and finally transmits the control signal to the PWM modulation control engine 312.

(4) The PWM modulation control engine 312 changes the operating rate of the PWM according to the control signal in Step (3), i.e., the width ratio, and outputs a PWM control signal to the LED drive circuit 102, so as to adjust the brightness of the red, green, and blue LEDs, to ensure the displaying brightness of the light source to be stable, and thereby obtaining the desired color stably.

The control timing diagram in this embodiment is shown in FIG. 7, and the control method is the same as that in the first embodiment. That is, the data sampling is performed in a low level period when the light source is turned off, so as to get the output information of the photo-sensor 220, and then, the light source is fed back and adjusted according to the information, thereby compensating the color and brightness.

In view of the above, the method for controlling the brightness and color balance of the light source provided by the present invention is to perform the data sampling when the light source is turned off. Since the light source driver is also turned off while the light source is turned off, the influence of system noises caused by the driver when the light source is lightened can be avoided, the signal-to-noise ratio can be enhanced, the detection accuracy of the change of the light source can be improved, and thereby more effectively controlling the brightness of the light source.

The apparatus and method for controlling the brightness of the light source provided by the present invention may be applied in any system requiring a stable light source, for example, applied in LED illumination, a backlight source system, or various display devices, and for example, the apparatus and method are applied in an LCD to offer a stable backlight source for the LCD.

However, the photo-sensors 106 and 220 applied in the present invention may be color sensors, photodiodes, or ambient light sensors, and the number of the photo-sensors 106 and 220 is not restricted, which may be determined upon actual requirements.

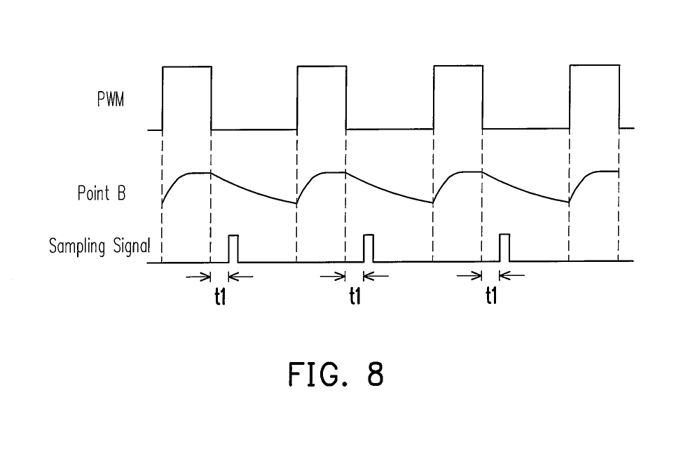

However, the method for controlling the brightness of the light source provided by the present invention is also suitable for the circumstances that the frequency for turning on and off the light source is very low (less than 200 Hz), the photo-sensor has a strong driving capability, or no suitable filter circuit exists. Under the aforementioned circumstances, for example, the voltage at Point B shown in FIG. 3 is not similar to a DC voltage, and at this time, a voltage change during a fixed time period after the light source is turned off can be taken as a basis for determining the intensity of the light source. A mechanism of a potential diagram showing rising (due to being changed), maintaining, and attenuating of the voltage at Point B is shown in FIG. 8. In FIG. 8, during a time period that the PWM is turned on, the voltage at Point B rises due to being charged according to the characteristics of the RC circuit, and once the PWM is turned off, Point B begins discharging. However, due to the RC constant of the circuit, a substantially fixed attenuation curve exists. Therefore, after the PWM is turned off, at the sampling time point t1, the potential at Point B is still maintained at a certain value under normal conditions. If the condition is changed, the potential at this sampling point will turn to be abnormal.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for controlling brightness of a light source, applicable for controlling a light source unit to obtain the brightness of a target light source, comprising:
a photo-sensor, for detecting a change of a light source; and
a lighting management and control circuit, for providing a control and adjustment signal for the light source unit according to a feedback signal of the photo-sensor;
wherein the lighting management and control circuit gets an output signal of the photo-sensor when the light source is turned off, and calculates and adjusts the light source according to the detected output signal, thereby compensating the change of the brightness of the light source.

2. The apparatus for controlling the brightness of a light source as claimed in claim 1, wherein the light source comprises a light emitting diode (LED).

3. The apparatus for controlling the brightness of a light source as claimed in claim 1, wherein the photo-sensor comprises a color sensor, a photodiode, or an ambient light sensor.

4. The apparatus for controlling the brightness of a light source as claimed in claim 1, wherein the lighting management and control circuit comprises a light source management controller and a filter circuit, and the filter circuit is connected to an output of the photo-sensor and an input of the lighting management and control circuit.

5. The apparatus for controlling the brightness of a light source as claimed in claim 1, wherein the lighting management and control circuit comprises a filter circuit, an analog to digital converter circuit, a light source management engine, and a pulse width modulation control engine.

6. A light source system, comprising:
a light source;
a photo-sensor, for detecting a change of the light source; and
a lighting management and control circuit, for providing a control and adjustment signal for the light source according a feedback signal of the photo-sensor;
wherein the lighting management and control circuit gets an output signal of the photo-sensor when the light source is turned off, and calculates and adjusts the light source according to the output signal, thereby compensating the brightness of the light source.

7. The light source system as claimed in claim 6, wherein the light source comprises an LED light source or an LED display matrix.

8. The light source system as claimed in claim 6, wherein the light source comprises red, green, and blue LED lamps.

9. The light source system as claimed in claim 8, wherein the lighting management and control circuit gets the output signal of the photo-sensor when the red, green, and blue LED lamps are turned off at the same time.

10. The light source system as claimed in claim 8, wherein the lighting management and control circuit gets the output signal of the photo-sensor corresponding to the red when the red LED lamp is turned off.

11. The light source system as claimed in claim 8, wherein the lighting management and control circuit gets the output signal of the photo-sensor corresponding to the green when the green LED lamp is turned off.

12. The light source system as claimed in claim 8, wherein the lighting management and control circuit gets the output signal of the photo-sensor corresponding to the blue when the blue LED lamp is turned off.

13. The light source system as claimed in claim 6, wherein the photo-sensor comprises a color sensor, a photodiode, or an ambient light sensor.

14. The light source system as claimed in claim 6, wherein the lighting management and control circuit comprises a light source management controller and a filter circuit, and the filter circuit is connected to an output of the photo-sensor and an input of the light source management controller.

15. The light source system as claimed in claim 6, wherein the lighting management and control circuit comprises a filter circuit, an analog to digital converter circuit, a light source management engine, and a pulse width modulation control engine.

16. A display apparatus, having a light source system, wherein the light source system comprises:
a light source;
a photo-sensor, for detecting a change of the light source; and
a lighting management and control circuit, for providing a control and adjustment signal for the light source according to a feedback signal of the photo-sensor;
wherein the lighting management and control circuit gets an output signal of the photo-sensor when the light source is turned off, and calculates and adjusts the light source according to the output signal, thereby compensating the brightness of the light source.

17. The display apparatus as claimed in claim 16, wherein the light source comprises an LED light source or an LED display matrix.

18. The display apparatus as claimed in claim 16, wherein the light source comprises red, green, and blue LED lamps.

19. The display apparatus as claimed in claim 18, wherein the lighting management and control circuit gets the output signal of the photo-sensor when the red, green, and blue LED lamps are turned off at the same time.

20. The display apparatus as claimed in claim 18, wherein the lighting management and control circuit gets the output signal of the photo-sensor corresponding to the red when the red LED lamp is turned off.

21. The display apparatus as claimed in claim 18, wherein the lighting management and control circuit gets the output signal of the photo-sensor corresponding to the green when the green LED lamp is turned off.

22. The display apparatus as claimed in claim 18, wherein the lighting management and control circuit gets the output signal of the photo-sensor corresponding to the blue when the blue LED lamp is turned off.

23. The display apparatus as claimed in claim 16, wherein the light source system is a light source module or a backlight module.

24. The display apparatus as claimed in claim 16, wherein the display apparatus comprises a liquid crystal display device.

25. A method for controlling brightness of a light source, comprising:
detecting a change of a light source through a photo-sensor;
getting an output signal of the photo-sensor when the light source is turned off; and
generating a control signal according to the output signal, so as to compensate the brightness of the light source.

26. The method for controlling the brightness of a light source as claimed in claim 25, wherein the control signal comprises an analog voltage signal or a digital value signal.

27. The method for controlling the brightness of a light source as claimed in claim 25, wherein when a frequency for turning on and off the light source is lower than a frequency value, or the photo-sensor has a strong driving capability, or no suitable filter circuit exists, a voltage change during a fixed time period after the light source is turned off is taken as a basis for determining the intensity of the light source.
